(19) United States
(12) Patent Application Publication
(10) Pub. No.: US 2016/0175837 A1
(43) Pub. Date: Jun. 23, 2016

(54) STORAGE CASSETTE AND RACK SYSTEM FOR BIOSPECIMENS

(71) Applicant: BLUECHIIP LIMITED, Scoresby, Victoria (AU)

(72) Inventors: Jason Phillip CHAFFEY, Blackburn South (AU); Haidong ZHENG, Ascot Vale (AU)

(21) Appl. No.: 14/907,535

(22) PCT Filed: May 30, 2014
(86) PCT No.: PCT/AU2014/000564

§ 371 Date: Jan. 25, 2016

Related U.S. Application Data
(60) Provisional application No. 61/858,755, filed on Jul. 26, 2013.

(51) Int. Cl. B01L 3/00

(52) U.S. Cl. CPC B01L 3/508; B01L 3/5457; B01L 2300/0809; B01L 2300/043; B01L 2300/045; B01L 2300/021; B01L 2200/025

(57) ABSTRACT

A storage cassette, including: a housing having a substantially hollow interior to receive a biospecimen container via a housing opening; a cover for closing the housing opening; a lock mechanism to be moved between a locked position in which the cover is maintained in a closed position and an unlocked position in which the cover can be moved to an open position; and a latch mechanism which, when the storage cassette is inserted into a rack, prevents inadvertent removal of the storage cassette from the rack. A rack, including a plurality of stacked rack elements, each rack element including an interlocking mechanism for securing adjacent rack elements, wherein each rack element is adapted to receive a storage cassette or each rack element includes a housing having a substantially hollow interior to receive a biospecimen container via a housing opening and a cover for closing the housing opening.

### FIELD OF THE INVENTION

The present invention relates generally to the storage and monitoring of biospecimens in a temperate control storage environment, such as the storage of tissue, blood, plasma, urine and other materials taken from the human body in cryogenic tanks or other reduced temperature environment.

### BACKGROUND OF THE INVENTION

Biospecimens are collected and stored in many different types of facilities for a great variety of applications. Such applications include the storage of samples collected during clinical trials in pharmaceutical companies, research samples used in university laboratories, samples archived in hospitals, samples used in the discovery of biological markers for diagnostic testing, forensic samples from crime or disaster scenes and so on. Cord blood and stem cell samples are one example of a biological sample required to be stored in very low temperature environments.

Typically in systems for storing bio samples, each of a large number of samples is stored in its own plastic bag, tube or other container. The small plastic bag, tube or other container is stored in a storage cassette with is in turn inserted into a rack. The rack holding a plurality of storage cassettes which each stores one or more biospecimens in a container is then placed in a temperature controlled storage environment, such as a cryogenic tank. Each tank typically stores a plurality of racks and accordingly stores a great many biological samples.

The use of aluminium or steel cassettes/canisters has been an established practice of many bio repositories. These cassettes are relatively cheap and require low technical skills in order to manufacture. The cassettes are formed into different sizes in order to accommodate different sized bags or samples. These bags contain biological fluids or samples for research or medical use. The bags are manufactured normally independently from the manufactures of the cassettes. The bags are typically manufactured in sizes that range from 50 ml up to 250 or 500 ml. The cassettes are stored in racks, which are also manufactured from aluminium or stainless steel. The overall approach to the above described system is low cost and simple, however there is little consideration given to user handling, safety or thermal considerations of the biospecimens contained inside the cassettes.

It would be desirable to provide a system for storing and monitoring biospecimens which addresses the above mentioned concerns. It would also desirable to provide a system for storing and monitoring biospecimens which ameliorates and/or overcomes one or more problems or inconveniences of the prior art.

The above discussion of background art is included to explain the context of the present invention. It is not to be taken as an admission that any of the material or equipment referred to was published, known, or part of the common general knowledge at the priority date of any of the claims of this specification.

### SUMMARY OF THE INVENTION

According to an aspect of the present invention, there is provided a storage cassette for storing biospecimens, including: a housing having a substantially hollow interior to receive at least one biospecimen container via a housing opening; and a cover for closing the housing opening.

In one or more embodiments, the storage cassette further includes a lock mechanism adapted to be moved between a locked position in which the cover is maintained in a closed position preventing access to the housing interior and an unlocked position in which the cover can be moved to an open position allowing access to the housing interior.

In one or more embodiments, the cover is pivotally attached at one side to the housing, and wherein the lock mechanism acts to secure an opposite side of the cover to the housing in the locked position and acts to release the opposite side of the cover from the housing in the unlocked position.

The storage cassette may further include a grip portion to enable manual movement of the lock mechanism between the locked and unlocked positions.

In one or more embodiments, the lock mechanism may be configured to move between the locked and unlocked positions in a linear direction along an edge of the storage cassette.

Alternatively, in one or more embodiments the lock mechanism is configured to move between the locked and unlocked positions respectively by being pushed towards and pulled away from the housing.

In one or more embodiments, the storage cassette may further include a locked/unlocked state indicator observable by a human operator.

In one or more embodiments, the cover is transparent to allow a human operator to visually inspect the housing interior.

In one or more embodiments, the housing is coloured to provide a visual indication of the type of biospecimen housed in the storage cassette.

In one or more embodiments, one or both of the housing and cover may include an inner surface with ribbed contours to create an air insulation barrier for reducing thermal excursions of the biospecimen housed in the storage cassette.

In one or more embodiments, the storage cassette may further include a latch mechanism which, when the storage cassette is inserted into a rack, prevents inadvertent removal of the storage cassette from the rack.

The latch mechanism may include a projection for engagement in a corresponding aperture in the rack, the projection being located in the corresponding aperture when the storage cassette is inserted into the rack.

In one or more embodiment, the storage cassette includes means for affixing a machine readable tag to the cassette

According to another aspect of the invention, there is provided a rack for storing biospecimens, including a plurality of stacked rack elements, each rack element including one or more interlocking mechanisms for securing adjacent rack elements, wherein each rack element is adapted to receive a storage cassette as described here above.

According to yet another aspect of the present invention, there is provided a rack for storing biospecimens, including a plurality of stacked rack elements, each rack element including one or more interlocking mechanisms for securing adjacent rack elements, wherein each rack element includes a housing having a substantially hollow interior to receive at least one biospecimen container via a housing opening; a cover for closing the housing opening; and means for affixing a machine readable tag to the cassette.

In one or more embodiments, the rack may further include a handle secured to the upper most of the stacked rack elements.

### BRIEF DESCRIPTION OF THE DRAWINGS

Embodiments of the invention will now be described, by way of example only, with reference to the accompanying drawings. It is to be understood that the particularity of the drawings and embodiments does not supersede the generality of the preceding description of the invention.

In the drawings:

FIG. 1 is perspective view of a storage cassette according to one embodiment of the present invention;

FIG. 2 is a diagram depicting insertion of the storage cassette shown in FIG. 1 in an exemplary rack;

FIG. 3 is a depiction of the insertion of the rack shown in FIG. 2 into a cryogenic storage tank;

FIGS. 4 and 5 depict different embodiments of a latch mechanism to prevent inadvertent removal of the storage cassette shown in FIG. 1 from a rack;

FIGS. 6 to 8 depict three different embodiments of a lock mechanism for maintaining the storage cassette shown in FIG. 1 in a closed state;

FIG. 9 is a front view of a rack for storing biospecimens including a plurality of stacked rack elements according to one embodiment of the present invention; and

FIG. 10 is a perspective view of a rack element forming part of an alternate embodiment of a rack for storing biospecimens according to the present invention.

### DETAILED DESCRIPTION

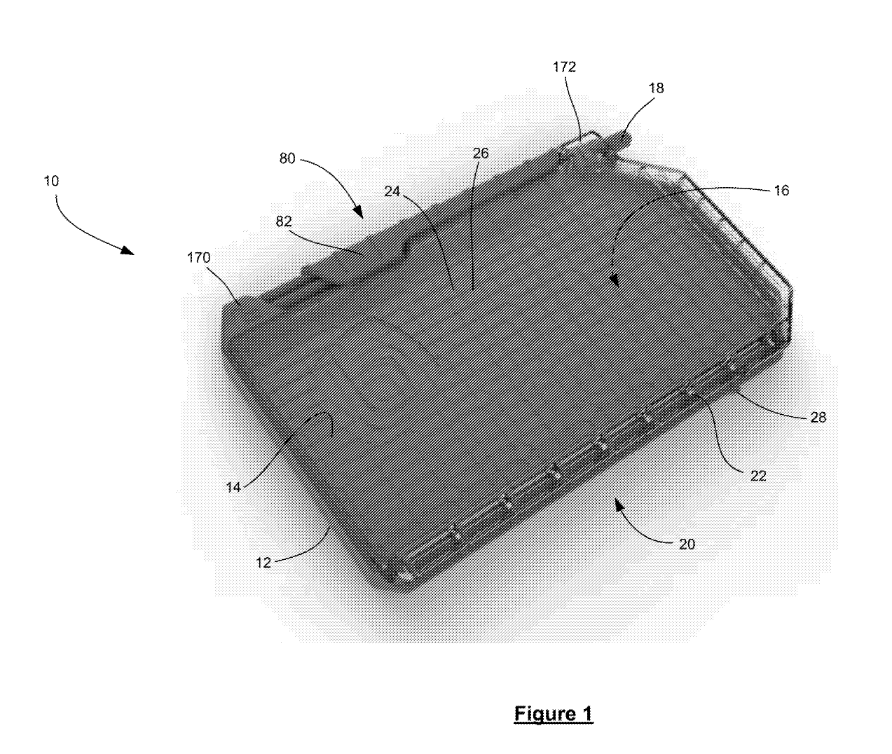

Referring now to FIG. 1, there is shown generally a storage cassette 10 for storing biospecimens. The storage cassette 10 includes a housing 12 and a cover 14. The housing 12 has a substantially hollow interior 16 for receiving at least one biospecimen container via a housing opening which, in the arrangement shown in FIG. 1, is closed by the cover 14.

A machine readable tag 18 is preferably provided on the storage cassette 10. The tag 18 is typically manufactured separately from, and then affixed to, the storage cassette 10 by suitable means. For example, a hole or aperture may be formed in the housing 12 into which a cylindrical machine readable tag may be inserted and fixed. In other embodiments, the storage cassette may not be provided and tracking/monitoring of the cassette and its contents may be performed by other means.

In this embodiment the storage cassette has a substantially rectangular shape and the cover 14 is pivotally attached on a first side 20 of the storage cassette by a hinge 22 running along the side 20 of the storage cassette. The shape of the storage cassette shown in FIG. 1 is adapted to be inserted into a conventional rack used for storing biospecimens in a cryogenic storage tank, however it will be appreciated that the storage cassette may have any convenient shape or configuration that may be suited to a particular storage environment.

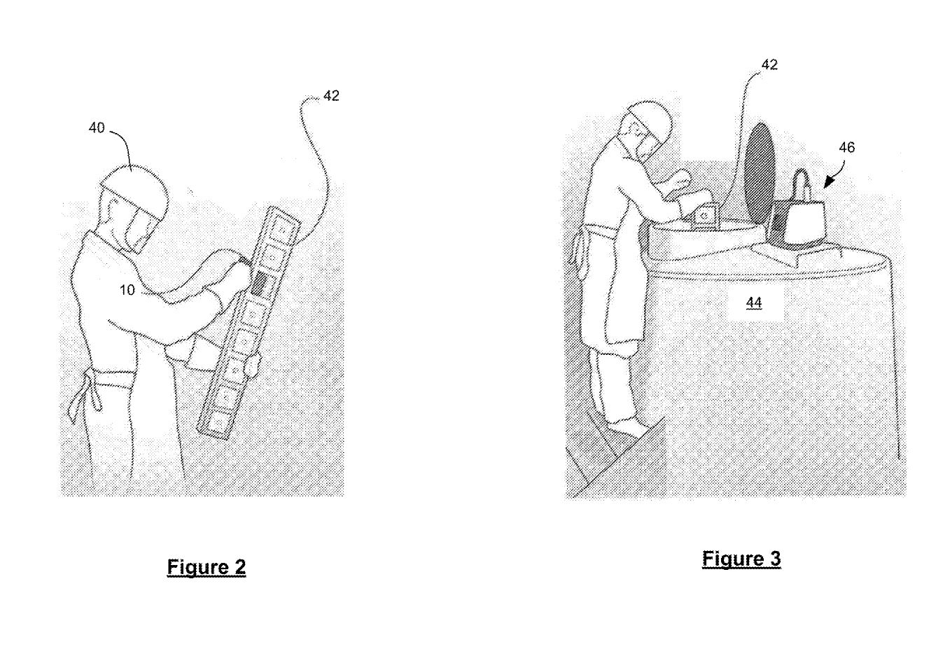

One such storage environment is depicted in FIGS. 2 and 3. FIG. 2 shows the insertion by an operator 40 of the storage cassette 10 into a rack 42. The rack 42 includes a series of slots into which a plurality of like storage cassettes can be inserted. In the arrangement shown in FIG. 2, the slots are arranged so that the various storage cassettes are disposed in a “stacked” configuration in which the storage cassettes are disposed on top of each other in the rack.

Once a desired number of storage cassettes have been arranged in the rack 42, the operator 40 then places the rack 42 into a tank 44 in which the temperature and possibly other storage conditions are controlled. The machine readable tag affixed to each storage cassette is able to be interrogated by the operator 40 via a tag interrogation device 46 in order not only to identify each storage cassette but also to monitor the temperature to which the biospecimen stored in the storage cassette has been exposed.

Details of embodiments of biospecimen storage cassettes, racks and tanks are described in International Patent Application No. WO 2013/053011 to the present Applicant, the entire contents of which is hereby incorporated into the present specification by reference. Details of an embodiment of a device for interrogating the machine readable tag are disclosed in International Patent Application No. WO 2010/037166 to the present Applicant, the entire contents of which are also incorporated into the present specification by reference.

The cover 14 of the storage cassette 10 as shown in FIG. 1 is transparent to allow a human operator to visually inspect the interior 16 of the housing. To that end, rather than being manufactured from aluminium or steel as is the case with prior art storage cassettes, the storage cassette 10 is preferably manufactured from a plastic material or materials.

In a similar vein, the housing 12 is preferably coloured to provide a visual indication of the type of biospecimens housed in the storage cassette. Several different coloured housings may be provided for various types of storage cassettes that may be inserted into the rack 42 and then subsequently placed in the tank 44, in order to enable easy identification of various types of biospecimens that may be stored within the various storage containers of the rack 42 and tank 44.

The storage cassette 10 includes a number of other advantageous features. For example, one or both of the housing 12 and cover 14 includes an inner surface with ribbed contours (which can be seen in FIG. 1 as the “checked” pattern on the interior surface of the cover 14) which act to create an air insulation barrier for reducing thermal excursions of the biospecimen housed in the storage cassette 10. Exemplary ribbed contours are referenced 24 and 26 in FIG. 1.

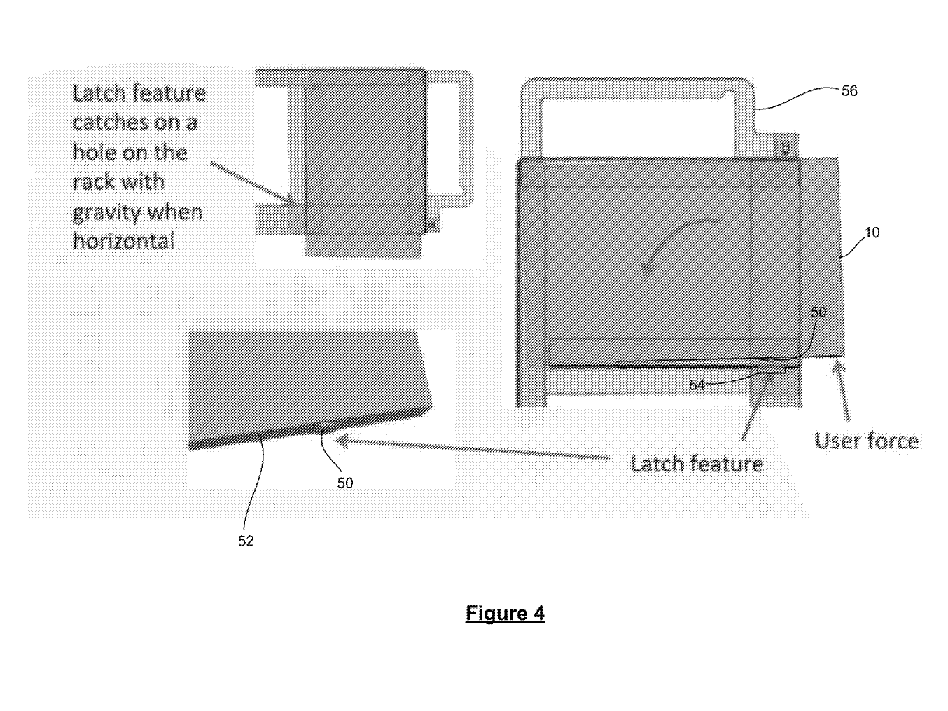

The storage cassette 10 also includes a latch mechanism 28 which, when the storage cassette 10 is inserted into a rack 42, prevents inadvertent removal of the storage cassette 10 from the rack 42. A first embodiment of the latch mechanism 28 is depicted in FIG. 4. This embodiment of the latch mechanism includes a projection 50 extending from an edge 52 of the storage cassette 10. The projection 50 is adapted to be located in a corresponding aperture 54 in a rack 56. The relative orientation of the rack and storage cassette, when inserted into the rack, is such that the projection 50 is held in place within the aperture by gravity when the rack is located in the container 44. As can be seen in FIG. 4, the slot in the rack 56 in which the storage cassette 10 is introduced has dimensions which are slightly larger than those of the storage cassette in order that a user force applied to the bottom of the storage cassette acts to free the projection 50 from the aperture 54 so that the storage cassette 10 can be removed from the rack 56.

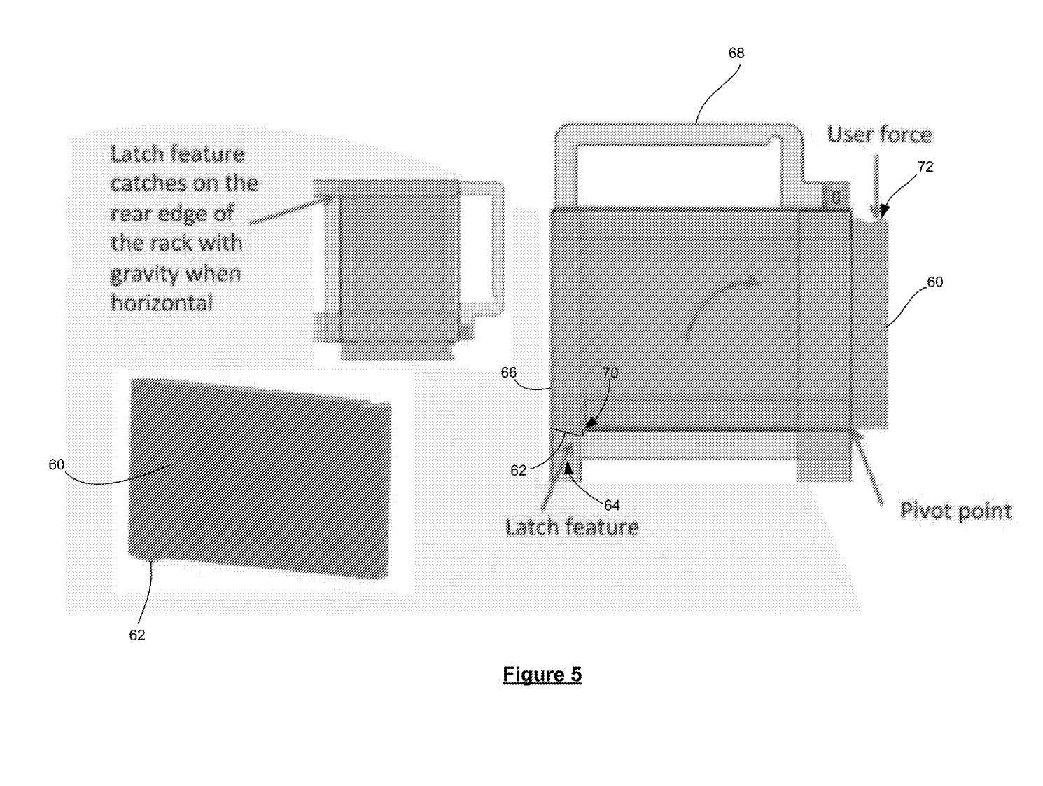

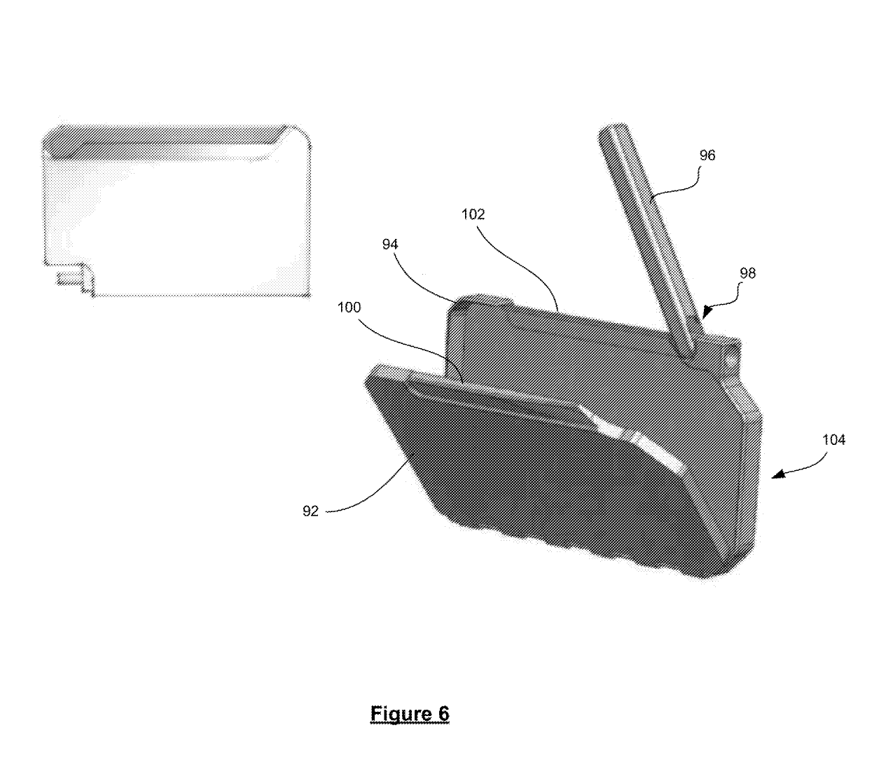

An alternative embodiment of the latch feature is depicted in FIG. 5. In this embodiment, the storage cassette 60 includes a projection 62 designed to be located in an aperture 64 defined between a rear wall 66 of a rack 68 and a lip 70 of an internal rack element. Rather than being located part way along an edge of the storage cassette, as was the case in the embodiment shown in FIG. 4, the projection 62 is located at the end of one side of the storage cassette 60. A user force may be applied to an opposite side and edge 72 of the storage cassette 60 in order to withdraw the projection 62 from the aperture 64 so that the storage cassette 60 can be withdrawn from the rack 68.

Whilst FIGS. 4 and 5 depict two embodiments of a latch mechanism for preventing inadvertent removal of the storage cassette from the rack, in other embodiments of the invention the latch mechanism could be magnetic or rely upon other cooperating latching elements.

Returning once again to FIG. 1, the storage cassette 10 may further include a lock mechanism adapted to be moved between a locked position in which the cover 14 is maintained in an enclosed position preventing access to the housing interior 16 and an unlocked position in which the cover 14 can be opened allowing access to the housing interior 16. The storage cassette 10 may further include a grip portion 82 to enable manual movement of the lock mechanism between the locked an unlocked position.

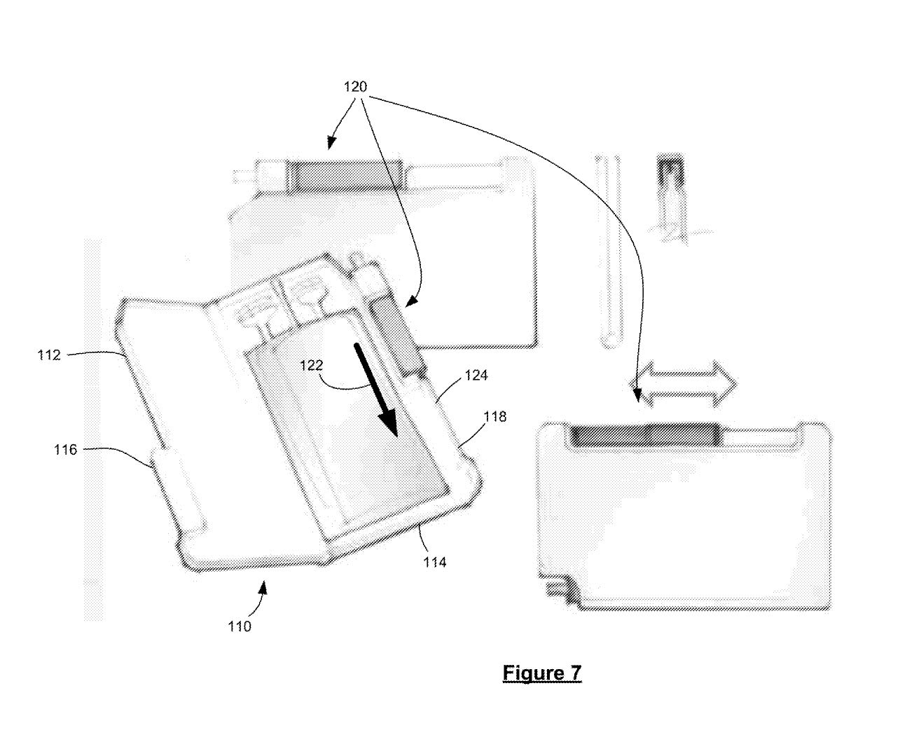

In a first embodiment of the lock mechanism shown in FIG. 6, a cover 92 and housing 94 are shown in an open configuration. A locking member 96 is pivotally attached to the housing 94 at a pivot point 98. Once the storage cassette is closed by bring the cover 92 towards to housing 94, an edge portion 100 of the cover and an edge portion 102 of the housing are brought into abutment. The lock member 96 includes a channel. When the edge portions 100 and 102 are brought into abutment, the lock member 96 is pivoted about the pivot point 98 and the channel of the lock member 96 is brought over the two edge portions 100 and 102 in order to maintain the storage cassette 104 shown in FIG. 6 in a locked position.

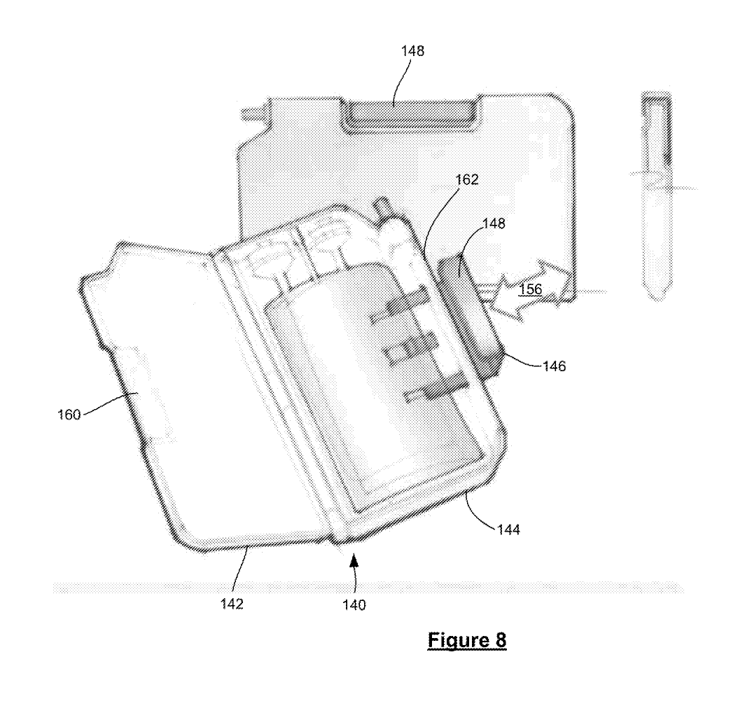

FIG. 7 shows an alternative embodiment of the lock mechanism. In this Figure, a storage cassette 110 is depicted which includes a cover 112 and a housing 114. The cover 112 includes an edge portion 116 designed to be brought into abutment with an edge portion 118 of the housing 114 when the storage cassette is closed. A lock mechanism 120 is configured to be moved between a locked position in which the edge portion 116 is placed against the edge portion 118 by movement in a linear direction shown by the arrow 122 along an edge 124 of the storage cassette 110. When the lock mechanism is moved in a linear direction opposite to that depicted by the arrow 122, the edge portions 116 and 118 are no longer maintained together and the cover is able to be moved away from the housing in order to open the storage cassette.

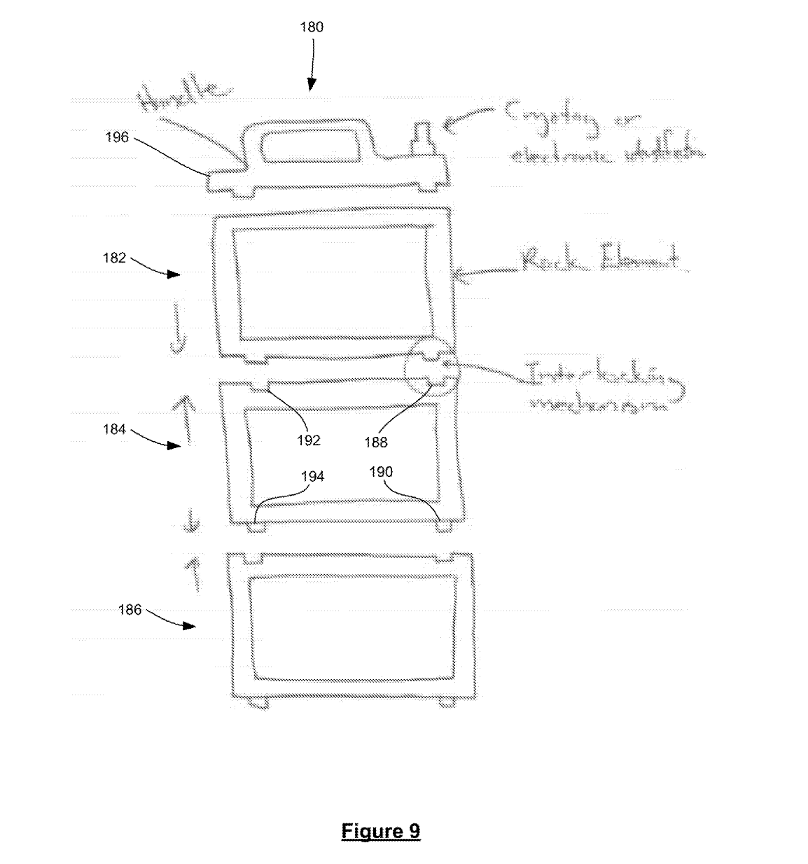

FIG. 8 shoes a further variant in which the lock mechanism is configured to move between locked and unlocked positions respectively by being pushed towards and pulled away from the housing. As can be seen in this Figure, the storage cassette 140 includes a cover 142 and housing 144. A locking mechanism 146 includes an exterior channel portion 148 affixed to projections 150 to 154 adapted to slide through corresponding apertures in the wall of the housing 144. The lock mechanism is adapted to be movable towards and away from the housing 144 as indicated by the bi-headed arrow 156. In order to place the storage cassette 140 into a locked position, the cover 142 is pivoted along an edge 158 so that an edge portion 160 of the cover is brought into abutment with an edge portion 162 of the housing 144. The lock mechanism 156 is then pushed towards the housing 144 so that the channel member 148 is brought around the outside of the edge portion 160 thereby preventing the cover from being pivoted away from the housing 144.

It will be appreciated that other embodiments of storage cassette may include different lock mechanisms to those depicted in FIGS. 6 to 8.

Referring again to FIG. 1, the storage cassette may further include a locked/unlocked state indicator, exemplarily ones of which are 170 and 172 in order to provide an indication of the locked/unlocked state of the cassette and thus the status of the storage cassette integrity.

It can be further seen from FIG. 1, that the grip portion 82 enabling manual movement of the lock mechanism between the locked and unlocked position may include ribbing or other features assisting manual manipulation.

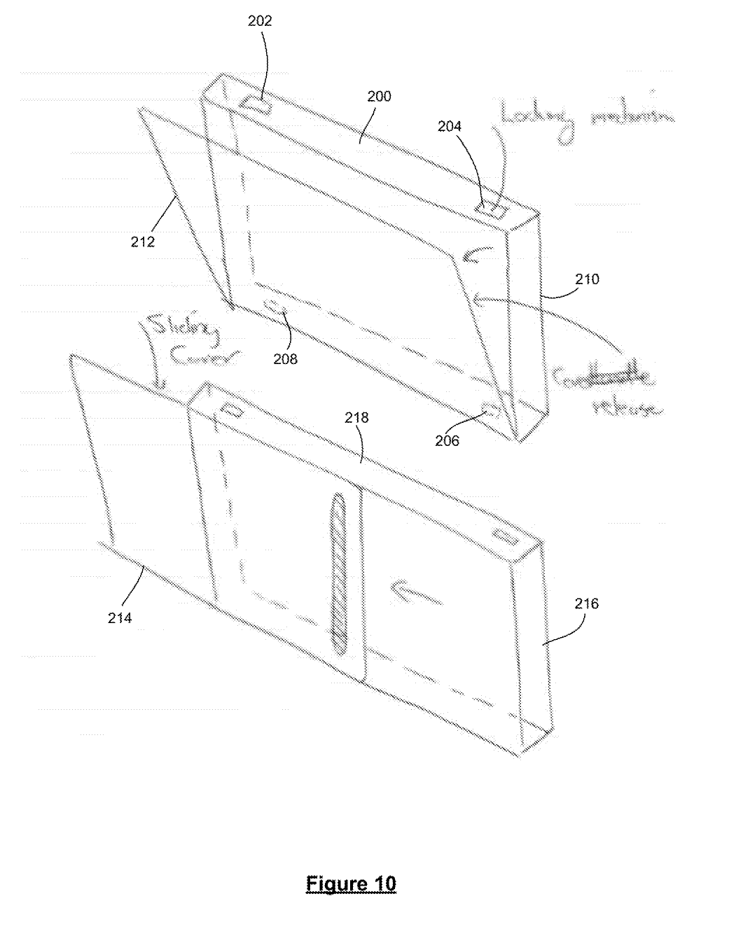

Although shown to be of unitary construction in FIG. 2, the rack in which the storage cassettes are inserted for placement in the tank 44 may also be of modular design. This design, which is depicted schematically in FIG. 9, allows for different sized cassettes to be attached, the number of cassette locations to be controlled and groupings of samples and their type to be organised. Being of unitary construction, current racks have no other purpose but to hold storage cassettes, and in many cases the racks are built to fit tanks. The racking system depicted in FIG. 9 provides for modular rack elements to be interlocked together in a convenient manner. To that end, FIG. 9 shows a rack 180 or storing biospecimens. The rack 180 includes stacked rack elements 182 184 and 186. Each of the rack elements 182 to 186 includes one or more interlocking mechanisms for securing adjacent rack elements.

In the example shown in FIG. 9, the lock elements 182 to 186 each include a plurality of locking members on a lower surface adapted to engage with corresponding locking members on an upper surface of an adjacent rack element. Each rack element also includes a plurality of lock members on its upper surface adapted to engage with corresponding lock elements on the lower surface of an adjacent rack element. Exemplarily lock members for the rack element 184 are referenced 188 to 194. The rack elements 182 to 186 each include provision for the insertion of a storage cassette.

The rack 180 further includes a handle 196 which includes lock members configured to engage with corresponding lock members on an upper most rack element in the rack 180. Conveniently, a machine readable tag may be affixed to the handle 196.

It will be appreciated that the arrangement depicted in FIG. 9 enables a rack to be constructed from modular elements and for the subsequent insertion of storage cassettes into with modular element. However, in the embodiment depicted in FIG. 10, the functionality of the rack and the storage cassette may be combined. To that end, FIG. 10 shows a single rack element 200 suitable for use in a rack on modular design. The rack element 200 includes locking members 202 to 208 for engagement with cooperating lock members on adjacent rack elements.

However, rather than merely being configured to enable the insertion of a storage cassette, the rack element 200 includes a housing 210 and cover 212 of the sort described in relation to FIGS. 1 and 6 to 8 in particular. That is, the housing 210 includes a substantially hollow interior to receive at least on biospecimen container and the cover 212 acts to close the storage cassette opening in order to securely contain the biospecimens container. Whilst the cover 212 is shown as being pivotally attached to the housing 210, various other means for attaching the cover to the housing can be envisaged. For example, a slideably mounted cover 214 may be provided on a housing 216 which together form an alternative embodiment 218 of the rack element shown in FIG. 10.

Various advantageous are provided by the above mentioned embodiments of the invention. These include the following: The storage cassettes are prevented from inadvertently falling out of storage racks during use;
Prior art storage cassettes are based on metal designs and do not allow a user to visually inspect the interior of a storage cassette prior to opening. The present invention enables unnecessary thermal excursions to be prevented by assisting a human operator to locate a relevant sample by visual inspection through the transparent cover.
All cassettes are able to be colour coded and thereby provide a basic visual classification for handling, storage and retrieval purpose. The storage cassettes are optimised for thermal performance in order to reduce thermal excursion and warm up rates out of a cryogenic storage environment.
Electronic identification associated with a rack or cassette is provided in order to enable electronic identification to occur during use or handling.
An integrated cassette and rack system enables a reduction of cost and number of components to be minimised.
A modular rack system enables users to customise or modify racks to suit their needs, and tanks and new tanks which may be of different sizes, as space inside a storage tank is typically at a premium.

Whilst the invention has been described in conjunction with a limited number of embodiments, it will be appreciated by those in the art that many alternatives, modification or variations are possible in light of the foregoing description. The present invention is intended to embrace all such alternatives, modifications and variations as may fall within the spirit and scope of the invention as disclosed.

1. A storage cassette for storing biospecimens, comprising:
a housing having a substantially hollow interior to receive at least one biospecimen container via a housing opening; and
a cover for closing the housing opening.

2. A storage cassette according to claim 1, and further comprising:
a lock mechanism adapted to be moved between a locked position in which the cover is maintained in a closed position preventing access to the housing interior and an unlocked position in which the cover can be moved to an open position allowing access to the housing interior.

3. A storage cassette according to claim 2, wherein the cover is pivotally attached on one side to the housing, and wherein the lock mechanism acts to secure an opposite side of the cover to the housing in the locked position and acts to release the opposite side of the cover from the housing in the unlocked position.

4. A storage cassette according to claim 3, and further comprising a grip portion to enable manual movement of the lock mechanism between the locked and unlocked positions.

5. A storage cassette according to claim 4, wherein the lock mechanism is configured to move between the locked and unlocked positions in a linear direction along an edge of the storage cassette.

6. A storage cassette according to claim 4, wherein the lock mechanism is configured to move between the locked and unlocked positions respectively by being pushed towards and pulled away from the housing.

7. A storage cassette according to claim 2, and further comprising a locked/unlocked state indicator observable by a human operator.

8. A storage cassette according to claim 2, wherein the cover is transparent to allow a human operator to visually inspect the housing interior.

9. A storage cassette according to claim 2, wherein the housing is coloured to provide a visual indication of the type of biospecimen housed in the storage cassette.

10. A storage cassette according to claim 2, wherein one or both of the housing and cover include an inner surface with ribbed contours to create an air insulation barrier for reducing thermal excursions of the biospecimen housed in the storage cassette.

11. A storage cassette according to claim 2, and further comprising a latch mechanism which, when the storage cassette is inserted into a rack, prevents inadvertent removal of the storage cassette from the rack.

12. A storage cassette according to claim 11, wherein the latch mechanism comprises a projection for engagement in a corresponding aperture in the rack, the projection being located in the corresponding aperture when the storage cassette is inserted into the rack.

13. A storage cassette according to claim 2, and further comprising:
means for affixing a machine readable tag to the cassette.

14. A rack for storing biospecimens, comprising:
a plurality of stacked rack elements, each rack element comprising one or more interlocking mechanisms for securing adjacent rack elements, wherein
each rack element is adapted to receive a storage cassette according to claim 2.

15. A rack for storing biospecimens, comprising:
a plurality of stacked rack elements, each rack element comprising one or more interlocking mechanisms for securing adjacent rack elements, wherein
each rack element comprises:
a housing having a substantially hollow interior to receive at least one biospecimen container via a housing opening;
a cover for closing the housing opening; and
means for affixing a machine readable tag to the cassette.

16. A rack according to claim 14, and further comprising a handle secured to the upper most of the stacked rack elements.

17. A rack according to claim 15, and further comprising a handle secured to the upper most of the stacked rack elements.
